(19) United States
(12) Patent Application Publication
(10) Pub. No.: US 2007/0022781 A1
(43) Pub. Date: Feb. 1, 2007

(54) Method for producing polarizing glass

(75) Inventors: Yuichi Aoki, Niigata (JP); Masahiro Ichimura, Tokyo (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/192,980

(22) Filed: Jul. 29, 2005

(51) Int. Cl. C03C 10/16; C03B 21/00; C03B 23/00

(52) U.S. Cl. 65/33.3; 65/103

(57) ABSTRACT

There is provided a manufacturing method of polarizing glass in which a time required for a reducing step is shortened. The manufacturing method of polarizing glass includes steps of precipitating metal halide dispersed within glass into a predetermined particle size to form glass preform after melting the glass containing the metal halide, elongating the glass preform after heating up to predetermined temperature to form a glass sheet and reducing the metal halide particles within the glass sheet at temperature higher than melting point of the metal halide.

### FIELD OF THE INVENTION

The present invention relates to a manufacturing method of polarizing glass and more specifically to a manufacturing method of polarizing glass having an elongating step of elongating metal halide particles contained in glass preform to obtain a glass sheet.

### BACKGROUND TECHNOLOGY

Polarizing glass is used in a polarization dependent optical isolator in a near-infrared region for use in optical communications. The optical isolator has two polarizing glass sheets and a magnetic garnet film interposed between them. The optical isolator transmits light entering from a laser diode (LD), i.e., a light source, and cuts off light returning to the LD.

The polarizing glass used in the optical isolator is manufactured through steps of melting base glass containing halide, precipitating (or heat-treating) metal halide particles within the mother glass, elongating the glass containing the metal halide particles, polishing the elongated glass and reducing the metal halide particles within the glass sheet as disclosed in Japanese Patent Laid-Open No. 2005-47734 for example cited herein as a patent document.

The patent document describes that the reducing reaction in the reducing step depends on ambient temperature and reducing time. More specifically, the patent document describes that although the reducing time may be shortened if the ambient temperature is high, the metal halide particles melt and are re-globulized, thus decreasing an aspect ratio thereof and disabling to obtain a desirable extinction ratio, if the ambient temperature exceeds the melting point of the metal halide. Then, according to the patent document, the ambient temperature of the reducing step is preferable to be less than the melting point of the metal halide.

However, there is a problem that if the ambient temperature in the reducing step is low, it takes more time for the reducing reaction to take place in the reducing step, which is also described in the patent document described above.

### SUMMARY OF INVENTION

In order to solve the above-mentioned problem, according to a first aspect of the invention, a manufacturing method of polarizing glass includes steps of precipitating metal halide dispersed within glass into a predetermined particle size to form glass preform after melting the glass containing the metal halide, elongating the glass preform after heating to predetermined temperature to form a glass sheet containing metal halide particles and reducing the metal halide particles in the glass sheet at temperature higher than melting point of the metal halide. Thereby, the time required for the reducing step may be shortened. Still more, because the metal halide particles within the glass sheet melt and flow, more metal halide contacts with the reducing atmosphere to be reduced.

In the first aspect of the invention described above, the glass sheet may be rocked. It enables the metal halide particles having the fluidity within the glass sheet to be reduced effectively in a shorter time.

Still more, the predetermined particle size may be 60 nm or less in the precipitating step. Thereby, the metal halide particles will not be re-globulized even if they undergo the elongating and reducing steps, i.e., the post-precipitating steps, and as a result, it becomes possible to provide polarizing glass having favorable optical characteristics.

Or, the temperature in the reducing step may be lower than transition temperature of the glass. Thereby, because the glass is in a rigid state, the elongated metal halide particles within the glass sheet is hardly re-globulized even if they are in a liquid state.

Still more, the glass preform may be heated up to temperature for which viscosity thereof becomes 1×10⁸ poise to 1×10¹⁴ poise and may be pulled by tensile force of 100 Kg/cm² to 700 Kg/cm² in the elongating step. Thereby it is possible to control the aspect ratio of the elongated metal halide particles and to provide the polarizing glass meeting with the required optical characteristics.

As it is apparent from the above description, the time required for the reducing step may be shortened in manufacturing the polarizing glass. Still more, because the metal halide particles within the glass sheet melt and flow, more metal halide contacts with the reducing atmosphere and is reduced.

It is noted that the summary of the invention described above does not necessarily describe all the necessary features of the invention. The invention may also be a sub-combination of the features described above.

### BRIEF DESCRIPTION OF THE DRAWINGS

FIG. 1 shows a structure of a elongating device used in a elongating step of a preferred embodiment.

FIG. 2 shows a structure of tensile means in the elongating device.

FIG. 3 is a conceptual drawing showing a state in which metal halide particles are elongated.

FIG. 4 shows a structure of a rocking device for rocking glass sheets.

### DETAILED DESCRIPTION OF THE INVENTION

The invention will now be described based on a preferred embodiment while showing operations of the invention based on the drawings, which do not intend to limit the scope of the invention, but exemplify the invention. All of the features and the combinations thereof described in the embodiment are not necessarily essential to the invention.

A manufacturing method of polarizing glass of the present embodiment includes steps of melting base glass containing halide, precipitating metal halide particles within the base glass, elongating the glass containing the metal halide particles, annealing the elongated glass, polishing the annealed glass and reducing the metal halide particles within the polished glass.

Glass in which metal halides, e.g., AgCl and AgBr, are dispersed is used as the raw material of the glass in the present embodiment. Table 1 shows compositions of the base glasses of the present embodiment.

TABLE 1

| Composition | #1(wt %) | #2(wt %) | #3(wt %) |
|---|---|---|---|
| R₂O | 13 | 11.6 | 13 |
| Li₂O | 1.8 | 1.8 | 1.8 |
| Na₂O | 5.5 | 4.1 | 5.5 |
| K₂O | 5.7 | 5.7 | 5.7 |
| B₂O₃ | 18.2 | 18.1 | 18.2 |
| Al₂O₃ | 6.2 | 6.2 | 6.2 |
| SiO₂ | 56.3 | 56.3 | 56.3 |
| CuO | 0.01 | 0.006 | 0.01 |
| Ag | 0.24 | 0.22 | 0.22 |
| Cl | 0.16 | 0.24 | 0.14 |
| Br | 0.16 | 0.20 | 0.14 |
| ZrO₂ | 5.0 | 5.0 | 5.0 |
| TiO₂ | 2.3 | 2.3 | 2.3 |
| F | — | — | 0.5 |

In the precipitating step, glass preform is formed by precipitating the metal halide dispersed within the glass into a predetermined particle size after melting the glass containing the metal halide. More specifically, after melting the glass in which the metal halide is dispersed, the glass preform is cut out of the melted glass after forming into a sheet or a block. Then, the glass preform is heated to precipitate metal halide particles. The precipitated metal halide particles are considered to be mixed crystals of AgCl, AgBr or AgClBr. Here, the melting point of AgCl is 449° C. and that of AgBr is 434° C. Table 2 shows thermal characteristics of the material glasses of the embodiment. It is noted that an error of the temperature is around ±10° C.

TABLE 2

| | | | Annealing | |
|---|---|---|---|---|
| Composition | Straining | Transition | Point | Softening Point |
| of Glass | Temp. (° C.) | Temp. (° C.) | Temp. (° C.) | Temp. (° C.) |
| #1 | 440 | 515 | 540 | 700-730 |
| #2 | 435 | 505 | 530 | 700-730 |
| #3 | 430 | 500 | 520 | Below 700 |

An aspect ratio of the metal particle is a ratio of major axis and minor axis of the metal particle reduced in the reducing step after being elongated in the elongating step. The characteristics of the polarizing glass or an extinction ratio in particular is affected by this aspect ratio. Here, the larger the size of the metal halide particle is in the precipitating step, the more easily the metal halide particle is re-globulized when it is melted after elongating due to surface tension and the smaller the aspect ratio becomes. Accordingly, it is preferable to lessen the particle size so that the metal halide particles will not be re-globulized in the annealing and reducing steps. Then, the particle size of the metal halide particle to be precipitated is preferred to be 60 nm or less in the precipitating step of the embodiment. Thereby, the elongated metal halide particles are hardly re-globulized even if the glass sheet after elongating is heated up to temperature higher than the melting point of the metal halide in the annealing and reducing steps.

Next, the glass preform is heated to predetermined temperature and is elongated to form the glass sheet having the elongated metal halide.

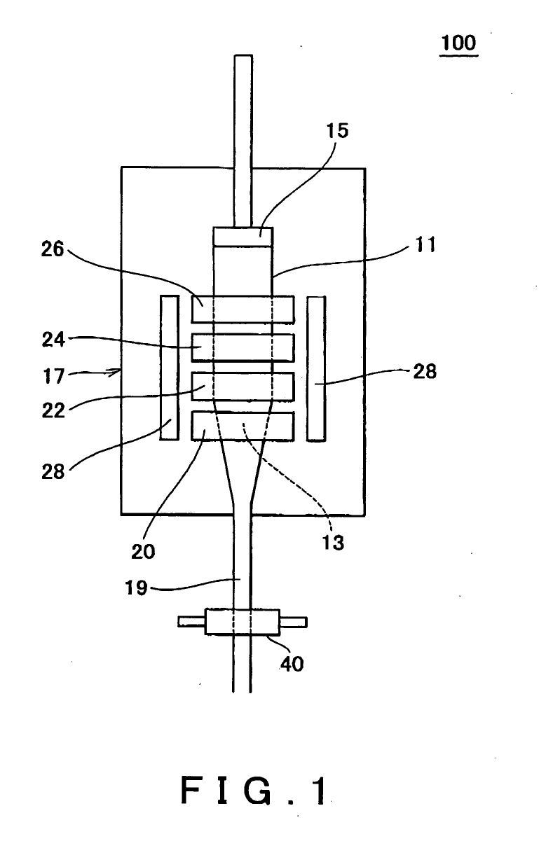

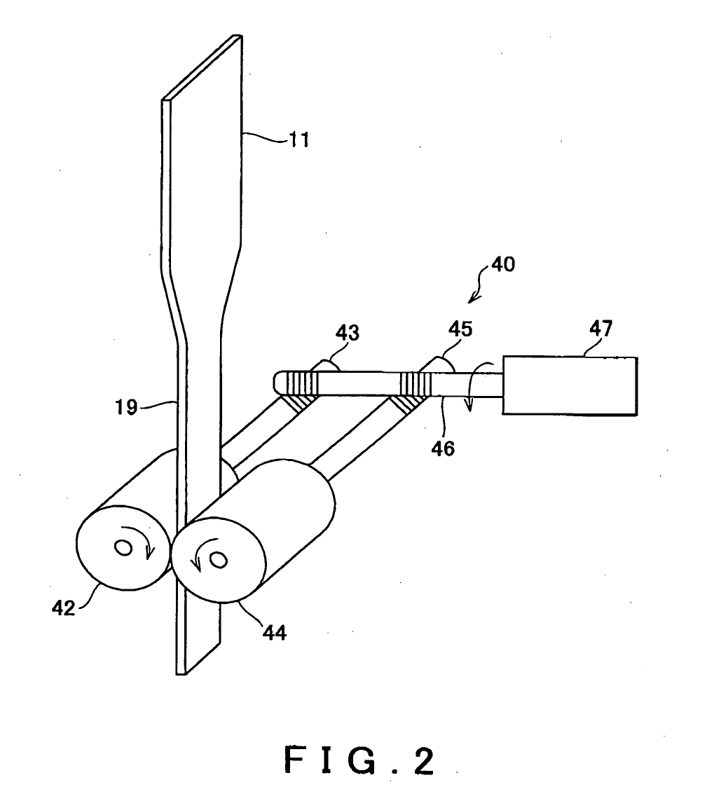

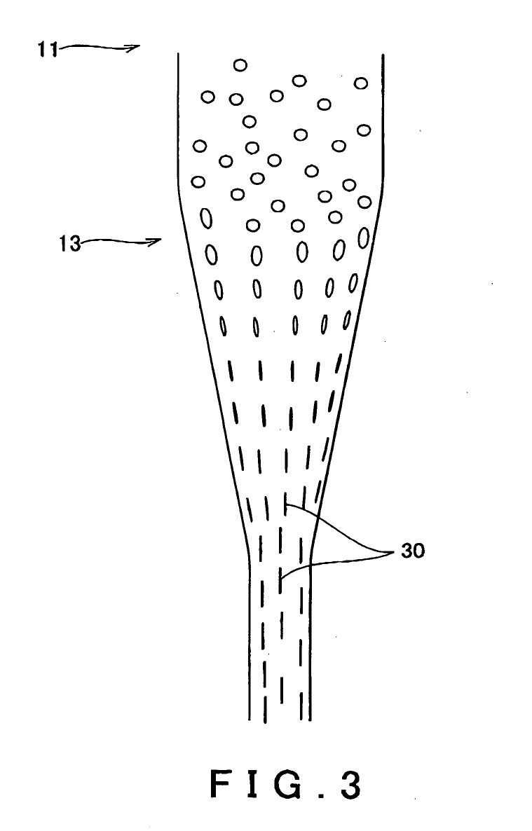

FIG. 1 shows a structure of a elongating device 100 used in the elongating step of the embodiment. FIG. 2 shows a structure of tensile means 40 in the elongating device 100. FIG. 3 is a conceptual drawing showing a state in which metal halide particles 30 within glass preform 11 are elongated when the glass preform 11 is elongated in the elongating step.

In the embodiment shown in FIG. 1, the elongating device 100 has an electric furnace 17, a glass supporter 15 provided within the electric furnace 17, a main heater 20 provided also within the electric furnace 17, sub-heaters 22, 24 and 26, a side heater 28 and the tensile means 40 provided under the various heaters described above in terms of the longitudinal direction of the glass preform 11.

The elongating device 100 elongates the glass preform 11 in which the metal halide is precipitated into a predetermined particle size through the precipitating step while heating by the main heater 20, the sub-heaters 22, 24 and 26 and the side heater 28 provided within in the electric furnace 17. Thereby, the metal halide particles 30 contained within the glass preform 11 are elongated and the glass sheet 19 containing the elongated metal halide particles 30 is formed. Concretely, the glass preform 11 is fixed by the glass supporter 15 and pulled by the tensile means 40 in the longitudinal direction while heating by the various heaters disposed around the glass preform 11. According to the embodiment, one end of the glass preform 11 is pulled downward by the tensile means 40 provided under the heaters while slowly moving down the glass supporter 15 for fixing the other end of the glass preform 11 formed in to a shape of strip in the longitudinal direction. The present embodiment will now be explained by using the positional relationship in FIG. 1. However, the direction for elongating the glass preform 11 is not limited to be the downward direction. For instance, an upper side of the glass preform 11 may be pulled upward by the tensile means 40 provided above the heaters by fixing the lower end of the glass preform 11 to the glass supporter 15.

The glass preform 11 is heated by the main heater 20 for heating around the center of the elongating section 13 in the width direction from the front side of the strip in the elongating section 13 where contraction of the glass preform 11 in the width direction occurs, the side heaters 28 for heating the sides of the elongating section 13 from the sides of the strip in the elongating section 13 and the sub-heaters 22, 24 and 26 disposed at predetermined intervals above the main heater 20.

Each width of the main heater 20 and the sub-heaters 22, 24 and 26 is slightly wider than that of the glass preform 11. Outputs of the main heater 20, the sub-heaters 22, 24 and 26 and the side heater 28 are controlled independently. Thereby, the glass preform 11 is heated with temperature distribution suited for the elongating. That is, the glass preform 11 is heated with the favorable temperature distribution for the elongation of the glass perform 11 and the metal halide particles 30 are elongated favorably as the glass preform 11 is elongated. The sub-heaters 22, 24 and 26 heat the upper part of the elongating section 13 step by step.

In the embodiment shown in FIG. 2, the tensile means 40 has a pair of rollers 42 and 44 that pinch the front and back faces of the glass sheet 19, plungers 43 and 45 that rotate in a body with the pair of rollers 42 and 44, respectively, a driving shaft 46 for rotating those plungers 43 and 45 mechanically in synchronism and a motor 47 for supplying rotational driving force to the driving shaft 46. According to the present embodiment, twisted gears having an equal pitch are formed on the plungers 43 and 45 and a gear engaging with those twisted gears is formed on the driving shaft 46.

In the present embodiment, it is preferable to heat the glass preform 11 up to temperature effecting from 1×10⁶ poise to 1×10¹⁴ poise of viscosity and to pull it with tensile stress of 100 Kg/cm² to 700 Kg/cm² in elongating.

After the elongating step described above, the glass sheet 19 is heated up to temperature below the transition temperature and above the straining temperature of the glass and is then cooled in the annealing step. Here, the annealing step includes heating and cooling operations, which is called “Yakinamashi” in Japanese, for relaxing residual stress (residual strain) caused within the internal structure of an individual material due to heat treatment and machining process. In the present embodiment, the annealing step includes the heating and cooling operations for removing the residual strain within the glass sheet 19 formed through the elongating step.

In the annealing step of the embodiment, the thermal characteristics and melting point of the metal halide shown in Table 1 is close to the straining temperature of glass. Accordingly, the metal halide particles 30 elongated in the glass sheet 19 are considered to be melting in the temperature range below the transition temperature and above the glass straining temperature. However, the glass sheet 19 itself keeps a rigid state and the metal halide particles 30 are held in the elongated shape by the surrounding glass phase even if it is melted.

If the glass sheet 19 is heated up to temperature above the transition temperature, the glass is put into a viscoelastic state, the metal halide particles 30 elongated within the glass sheet 19 are re-globulized and their aspect ratio drops. Accordingly, it becomes difficult to obtain desirable optical characteristics as polarizing glass such as the extinction ratio drop. Meanwhile, the residual strain within the glass sheet 19 is hardly removed if the glass sheet 19 is heated up only to temperature below the straining temperature.

Then, according to the present embodiment, after heating the glass sheet 19 to 480° C. which is below the transition temperature and above the glass straining temperature within an annealing furnace, it is held for 2.2 hours and is cooled naturally within the furnace after slowly lowering the temperature to 400° C. which is lower than the straining temperature with a pace of 1° C./minute or less.

After the annealing step described above, the annealed glass sheet 19 is polished in the polishing step. One side of the glass sheet 19 is polished at a time in the polishing step of the present embodiment. Concretely, the glass sheet 19 is pasted to a polishing table by means of wax and one side there of is polished at first. After ending polishing of one side, the polishing table is heated to soften the wax, the other side opposite to the polished side is exposed and is fixed again by the wax so that the exposed side is polished. A load which is not too heavy to break the glass sheet 19 is applied during polishing.

Thickness of the glass sheet 19 undergoing the polishing step is preferable to be close to target thickness after polishing because a polishing time may be shortened. However, the glass sheet 19 has subtle warp and curve. Then, according to the present embodiment, the glass sheet 19 undergoing the polishing step is formed so that its thickness is thicker than the target thickness by 200 μm (to be thicker by 100 μm per one side). It facilitates surfacing in the polishing step.

Although the method of polishing one side of the glass sheet 19 at a time has been used in the polishing step described above, there is also a method of polishing the both sides of the glass sheet 19 in the same time and the most suitable method may be adequately selected depending on the condition of the glass sheet 19 to be polished and on a target shape.

After the polishing step described above, the metal halide particles 30 within the glass sheet 19 are reduced in the reducing step. More specifically, polarizing characteristic is given to the glass sheet 19 from which the residual strain is removed through the annealing step by reducing at least part of the metal halide particles 30 elongated with in the glass sheet 19 as elongated metal particles.

The temperature of the glass sheet 19 in the reducing step may be lower than that of the glass sheet 19 heated in the annealing step. Still more, the temperature of the glass sheet 19 may be higher than the melting point of metal halide. Here, the temperature of the glass sheet 19 heated in the annealing step is 480° C. in the present embodiment.

The reducing step of the present embodiment is carried out by placing the glass sheet 19 within a chamber of hydrogen atmosphere and by heating for one to five hours at about 470° C.

Although the temperature within the furnace is lower than the glass transition temperature in the reducing step, it is higher than the melting point of the metal halide particles 30. Accordingly, although the metal halide particles 30 within the glass sheet 19 melt in the reducing step, they are considered to be held in the elongated shape by the surrounding glass phase similarly to the case in the annealing step. Still more, because the metal halide particles 30 flow within the shapes formed by the surrounding glass phase, the more metal halide contacts with the reducing atmosphere and is reduced as compared to a case of reducing the metal halide particles 30 at temperature lower than the melting point of the metal halide particles 30, i.e., when the metal halide particles 30 within in the glass sheet 19 are reduced in a solid state. Still more, as compared to the case of reducing the metal halide particles 30 at the temperature lower than the melting point of thereof, the reducing reaction takes place quickly, so that a time required for the reducing step may be shortened.

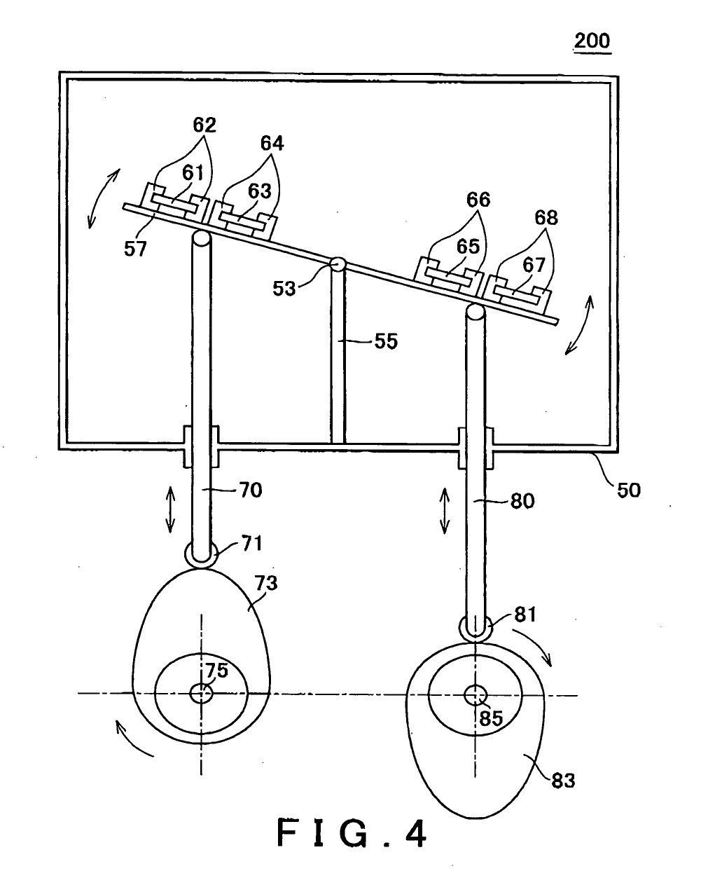

The glass sheet 19 may be also rocked in the reducing step. FIG. 4 shows a structure of a rocking device 200 for rocking glass sheets 61, 63, 65 and 67 within a chamber 50 kept in a reducing atmosphere in the reducing step of the present embodiment.

The rocking device 200 has a table 57 for supporting the glass sheets 61, 63, 54 and 67, a supporting rod 55 fixed at one face within the chamber So and having a hinge 53 at the end on the opposite side to the fixed side, left and right plungers 70 and 80 for supporting the both ends of the table 57, left and right cam followers 71 and 81 disposed respectively at the edges of the left and right plungers 70 and 80 on the opposite side to the side supporting the table 57 and left and right cams 73 and 83 contacting respectively with the left and right cam followers 71 and 81.

The supporting rod 55 supports the table 57 through an intermediary of the hinge 53. The table 57 is allowed to turn centering on the hinge 53 and reducing jigs 62, 64, 66 and 68 are fixed to the table 57 by screws or the like. Each of the reducing jigs 62, 64,66 and 68 has a pair of U-shaped fixtures facing to each other and each of the glass sheets 61, 63, 65 and 67 is inserted into and supported by a groove formed by the U-shaped fixtures facing to each other.

The left and right cams 73 and 83 are rotatably held in a body with left and right master shafts 75 and 85. Thereby, the left and right cams 73 and 83 rotate respectively in synchronism with the rotation of the left and right main shafts 75 and 85. Here, the left and right main shafts 75 and 85 are disposed in parallel, the left and right cams 73 and 83 have the same shape and lobes of the respective cams are disposed at a position 180 degrees opposite to the center of the master shafts. For instance, when the lobe of the left cam 73 faces right up (when it contacts with the left cam follower 71), the lobe of the right cam 83 faces right down.

When the rotation speed and direction of the left and right main shafts 75 and 85 are the same and as the left cam 73 starts to rotate from the state in which the lobe contacts with the left cam follower 71, the left plunger 70 moves down vertically. In the same manner, the right plunger 80 moves up vertically as the right cam 83 rotates. The table 57 supported by the left and right plungers 70 and 80 rocks centering on the hinge 53 from the position tilted left up (position in FIG. 4) to the position right up due to the vertical movement of the left and right plungers 70 and 80.

The metal halide particles 30 having the fluidity and contained in the glass sheets 61, 63, 65 and 67 retained in the reducing jigs 62, 64, 66 and 68 and placed on the surface of the table 57 on the opposite side where it is supported by the left and right plungers 70 and 80 may be effectively reduced in a short time by continuously repeating the series of operations described above.

As described above, according to the present embodiment, the temperature range of the annealing step for removing the residual strain caused within the glass sheet 19 through the elongating step may be widened in manufacturing the polarizing glass. Therefore, the temperature of the annealing step may be easily controlled, allowing to remove the residual strain within the glass sheet 19 more steadily.

Although the invention has been described by way of the exemplary embodiment, it should be understood that those skilled in the art might make many changes and substitutions without departing from the spirit and scope of the invention. It is obvious from the definition of the appended claims that the embodiment with such modifications also belongs to the scope of the invention.

1. A manufacturing method of polarizing glass, comprising steps of:
precipitating metal halide dispersed within glass into a predetermined particle size to form glass preform after melting said glass containing said metal halide;
elongating said glass preform after heating to predetermined temperature to form a glass sheet containing elongated metal halide particles; and
reducing said metal halide particles within said glass sheet at temperature higher than melting point of said metal halide.

2. The manufacturing method of polarizing glass as set forth in claim 1, wherein said glass sheet is rocked in said reducing step.

3. The manufacturing method of polarizing glass as set forth in claim 1, wherein said predetermined particle size is 60 nm or less in said precipitating step.

4. The manufacturing method of polarizing glass as set forth in claim 1, wherein said temperature in said reducing step is lower than glass transition temperature.

5. The manufacturing method of polarizing glass as set forth in claim 1, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

6. The manufacturing method of polarizing glass as set forth in claim 2, wherein said predetermined particle size is 60 nm or less in said precipitating step.

7. The manufacturing method of polarizing glass as set forth in claim 2, wherein said temperature in said reducing step is lower than glass transition temperature.

8. The manufacturing method of polarizing glass as set forth in claim 3, wherein said temperature in said reducing step is lower than glass transition temperature.

9. The manufacturing method of polarizing glass as set forth in claim 6, wherein said temperature in said reducing step is lower than glass transition temperature.

10. The manufacturing method of polarizing glass as set forth in claim 2, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

11. The manufacturing method of polarizing glass as set forth in claim 3, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

12. The manufacturing method of polarizing glass as set forth in claim 4, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

13. The manufacturing method of polarizing glass as set forth in claim 6, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

14. The manufacturing method of polarizing glass as set forth in claim 7, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

15. The manufacturing method of polarizing glass as set forth in claim 8, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.

16. The manufacturing method of polarizing glass as set forth in claim 9, wherein said glass preform is heated up to the temperature for which viscosity thereof becomes 1×10⁸ poise to 1×10¹⁴ poise and is pulled by tensile force of 100 Kg/cm² to 700 Kg/cm² in said elongating step.
